(19) United States
(12) Patent Application Publication
(10) Pub. No.: US 2019/0272470 A1
(43) Pub. Date: Sep. 5, 2019

(54) Rule-Based Classification for Detected Anomalies

(71) Applicant: Microsoft Technology Licensing, LLC, Redmond, WA (US)

(72) Inventors: Aditya Bandi, Sammamish, WA (US); Ishani Shailesh Parikh, Bellevue, WA (US); Laurent Serge Bernard Visconti, Bainbridge Island, WA (US)

(73) Assignee: Microsoft Technology Licensing, LLC, Redmond, WA (US)

(21) Appl. No.: 15/917,582

(22) Filed: Mar. 10, 2018

Related U.S. Application Data
(60) Provisional application No. 62/638,892, filed on Mar. 5, 2018.

(51) Int. Cl. G06N 5/02; G06F 17/30

(52) U.S. Cl. CPC G06N 5/025; G06F 17/30598

(57) ABSTRACT

Described herein is a system and method for classifying detected anomalies. Detected anomaly data comprising a plurality of anomaly data points is received. The detected anomaly data is labeled with a plurality of attributes using label logic for each of the plurality of attributes. The detected anomaly data is classified into one of a plurality of classifications based upon the attributes using a rule-based classification algorithm. The rule-based algorithm further determines a result for at least some of the anomaly data points. The classified detected anomaly data and the corresponding determined results are provided, for example, to a user.

### RELATED APPLICATION

This application claims priority to U.S. Provisional Application No. 62/638,892, filed Mar. 5, 2018, entitled “Rule-Based Classification for Detected Anomalies”, the disclosure of which is hereby incorporated by reference herein in its entirety.

### BACKGROUND

An anomaly can be defined as something that differs from expectations. In computer science, anomaly detection refers to identifying data, events, and/or conditions which do not confirm to an expected pattern or to other items in a group. Encountering an anomaly may in some cases indicate a processing abnormality and thus may present a starting point for investigation.

Anomaly detection is classified as supervised, semi-supervised or unsupervised, based on the availability of reference data that acts as a baseline to define what is normal and what is an anomaly. Supervised anomaly detection typically involves training a classifier, based on a first type of data that is labeled “normal” and a second type of data that is labeled “abnormal”. Semi-supervised anomaly detection typically involves construction of a model representing normal behavior from one type of labeled data: either from data that is labeled normal or from data that is labeled abnormal but both types of labeled data are not provided. Unsupervised anomaly detection detects anomalies in data where data is not manually labeled by a human.

### SUMMARY

Described herein is a system for classifying detected anomalies comprising a computer comprising a processor and a memory having computer-executable instructions stored thereupon which, when executed by the processor, cause the computer to: receive detected anomaly data comprising a plurality of anomaly data points; using label logic for each of a plurality of attributes, label the detected anomaly data with the plurality of attributes; classify the detected anomaly data into one of a plurality of classifications based upon the attributes using a rule-based classification algorithm, the rule-based algorithm further determines a result for at least some of the anomaly data points; and, provide the classified detected anomaly data and the corresponding determined results.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for classifying detected anomalies.

FIGS. 2-11 are graphs that illustrate example data for various scenarios.

FIG. 12 is a flow chart that illustrates a method of classifying detected anomalies.

FIG. 13 is a flow chart that illustrates a method of classifying detected anomalies.

FIG. 14 is a functional block diagram that illustrates an exemplary computing system.

### DETAILED DESCRIPTION

Various technologies pertaining to rule-based classification for detected anomalies are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding rule-based classification for detected anomalies. What follows are one or more exemplary systems and methods.

Aspects of the subject disclosure pertain to the technical problem of classifying and/or filtering detected anomalies. The technical features associated with addressing this problem involve using label logic for each of a plurality of attributes, labeling the detected anomaly data with the plurality of attributes. The detected anomaly data is classified into one of a plurality of classifications based upon the attributes using a rule-based classification algorithm. The rule-based algorithm further determines a result for at least some of the anomaly data points. The classified detected anomaly data and the corresponding determined results are provided, for example, to a user. Accordingly, aspects of these technical features exhibit technical effects of more efficiently and effectively providing results (e.g., information) to a user regarding detected anomalies, for example, reducing processing time and/or computer resource(s) associated with investigating potential cause(s) of the detected anomalies.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

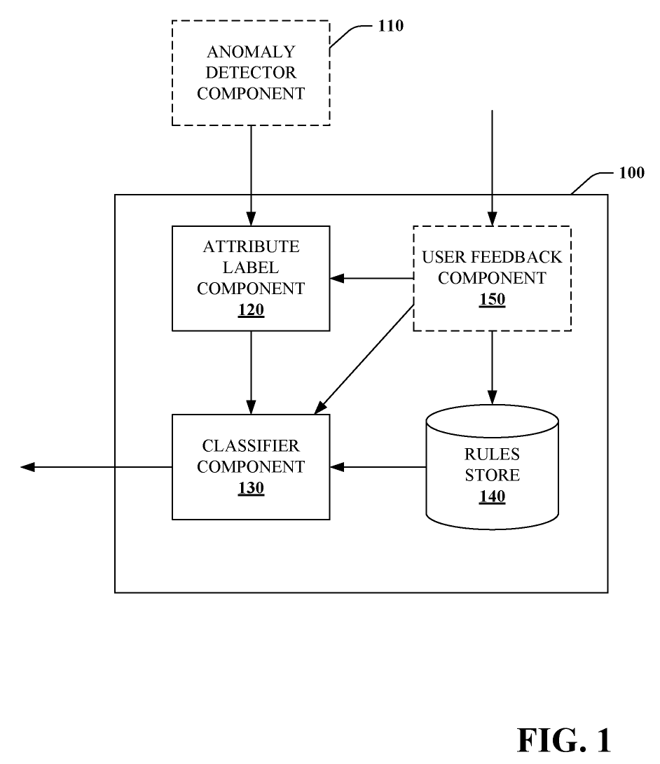

Referring to FIG. 1, a system for classifying detected anomalies 100 is illustrated. An anomaly detector component 110 can utilize a data anomaly algorithm to detect anomalies. The detected anomalies can be provided as detected anomaly data comprising a plurality of anomaly data points to the system 100. The detected anomaly data can be frustrating for a user to review/consume. For example, not all change point anomalies detected through the data anomaly algorithm might be of interest to the end user. Moreover, some of the anomalies detected may confuse the user as to what the change is.

Given the nature of change point anomaly detection it can take some time for the data anomaly algorithm to detect that a change happened. By the time the data anomaly is detected, a time series pattern may have changed in a manner in which it is difficult for the user to determine the impact of the change. This can result in the user having low confidence in the insight being reported in the data anomaly data.

The system 100 can post-process the detected anomalies data by removing anomaly data point(s) and/or providing information regarding anomaly data point(s). This post-processing can increase a user's ability to understand particular anomaly data point(s) and/or take corrective action, if necessary.

The system 100 includes an attribute label component 120 that labels the detected anomaly data with a plurality of attributes using label logic for each of the plurality of attributes. The label logic can specify criteria for labeling a particular attribute associated with a particular detected anomaly data point. In some embodiments, attributes have a Boolean value with the label logic applying one or more criteria to determine whether a value associated with the attribute (“0” or “1”). In some embodiments, values of the attributes can be used as an index into a classification table, as described below.

The system 100 further includes a classifier component 130 that classifies the detected anomaly data into one of a plurality of classifications based upon the attributes using a rule-based classification algorithm. The rules utilized by the rule-based classification algorithm can be stored in a rules store 140. In some embodiments, the classifier component 130 blocks and/or removes one or more anomaly data points.

In some embodiments, the rule-based algorithm can further determine a result for at least some of the anomaly data points. For example, the result can include information regarding a potential impact and/or reason why a user may find the particular anomaly data point significant. The classifier component 130 can provide the classified detected anomaly data and the corresponding determined results, for example, to a user.

Optionally, the user can provide feedback to the system 100 using a user feedback component 150. The user feedback component 150 can utilize a machine-learning algorithm to adapt the label logic of the attribute label component 120, the rule-based algorithm of the classifier component 130 and/or rules stored in the rules store 140 based upon the user feedback. In some embodiments, the user feedback component 150 can utilize one or more machine learning algorithms including linear regression algorithms, logistic regression algorithms, decision tree algorithms, support vector machine (SVM) algorithms, Naive Bayes algorithms, a K-nearest neighbors (KNN) algorithm, a K-means algorithm, a random forest algorithm, dimensionality reduction algorithms, and/or a Gradient Boost & Adaboost algorithm.

In some embodiments, the user can provide a positive indication with respect to one or more anomaly data points to the user feedback component 150. Based upon this positive feedback, the user feedback component 150 can adapt the label logic of the attribute label component 120, the rule-based algorithm of the classifier component 130 and/or rules stored in the rules store 140 to reinforce the algorithm used to provide the one or more anomaly data points.

In some embodiments, the user can provide a negative indication with respect to one or more anomaly data points to the user feedback component 150. Based upon this negative feedback, the user feedback component 150 can adapt the label logic of the attribute label component 120, the rule-based algorithm of the classifier component 130 and/or rules stored in the rules store 140 for use in classifying future detected anomaly data.

By way of example, and not limitation, in some exemplary embodiments, the system 100 includes three attributes to quantify change. Each attribute can have a value of 0 or 1 based on the criteria defined below.

A first attribute is “direction” which is based on a raw scored provided by the anomaly detector component 110 (e.g., data anomaly algorithm). The raw score is based on a difference of an observed value and an expected value. The label logic applied by the attribute label component 120 for this attribute is: (1) if the raw score is negative, then the direction is negative and the attribute is labeled as “0”; and, (2) if the raw score is positive, then the direction is positive and the attribute is labeled as “1”.

A second attribute is “percent change” which is calculated by comparing a sum of fact value (e.g., y-axis of a time series) for a current time period over a sum of fact value for a previous time period. The time period can be defined as, starting from the date/time when the anomaly was detected by the anomaly detector component 110 (e.g., data anomaly algorithm), looking back over a predetermined period of time (e.g., one week, 24 hours, etc.). For example, “percent change” can be defined as:

$$\frac{\begin{matrix}( Sum ( Fact Value current time period ) - \\ Sum ( Fact Value previous time period ) )\end{matrix}}{Sum ( Fact Value previous time period )} * 100$$

The label logic applied by the attribute label component 120 for this attribute is: (1) if the absolute value of the percent change is greater than or equal to a predetermined threshold and the percent change is greater than zero, then the attribute is labeled as “1”; (2) if the absolute value of the percent change is greater than or equal to a predetermined threshold and the percent change is less than zero, then the attribute is labeled as “0”; and, (3) in some scenarios, if neither condition (1) nor (2) applies, the heuristic is not applied to the detected anomaly and the anomaly is blocked and/or removed by the classifier component 130.

A third attribute is “rank” which is determined by obtaining a sorted list of the fact values in the last two-time periods and then identifying where the data point where the anomaly was detected ranks. For example, if a time series comprises the following values:

{(t1,15),(t2,18),(t3,21),(t4,19),(t5,17),(t6,13),(t7,11),(t8,16),(t9,20),(t10,23),(t11,26),(t 12,24),(t13,25),(t14,22)}
and an anomaly was detected on (t14, 22). Data point (t14, 22) has a rank of 0.71 as it has the 10^{th} highest value out of 14 possible values (10/14=0.71). In some embodiments, the label logic applied by the attribute label component 120 for this attribute is: (1) for data points having a rank greater than or equal to a threshold (e.g., 0.5), the attribute is labeled as “1”; (2) for data points having a rank less than the threshold (e.g., 0.5), the attribute is labeled as “0”. In some embodiments, the threshold is predetermined. In some embodiments, the threshold is determined dynamically, for example, based upon user feedback received from the user feedback component 150.

Table 1 sets forth eight possible variations of the three attributes discussed above and rules (e.g., stored in the rules store 140) applied by the classification component 130:

TABLE 1

| | | Percent | | |
|---|---|---|---|---|
| | | change | | |
| | | (1 = | Rank | |
| | | % change | Range | |
| | | >= | (1 = | |
| | Direction | threshold | Rank > | |
| | (1 = | 0 = | 0.5 | |
| | positive, | % change | 0 = | |
| | 0 = | <= | Rank < | |
| Case | negative) | threshold) | 0.5) | Classification |
| 0 | 0 | 0 | 0 | negative change point (CP) |
| 1 | 0 | 0 | 1 | Block/remove |
| 2 | 0 | 1 | 0 | If Rank == 0 than negative |
| | | | | change point else Block/remove. |
| | | | | Rank is reported in magnitude |
| | | | | but no % change. |
| 3 | 0 | 1 | 1 | Block/remove |
| 4 | 1 | 0 | 0 | Block/remove |
| 5 | 1 | 0 | 1 | If Rank == 1 than positive |
| | | | | change point else Block/remove. |
| | | | | Rank is reported in magnitude |
| | | | | but no % change. |
| 6 | 1 | 1 | 0 | Block/remove |
| 7 | 1 | 1 | 1 | positive change point |

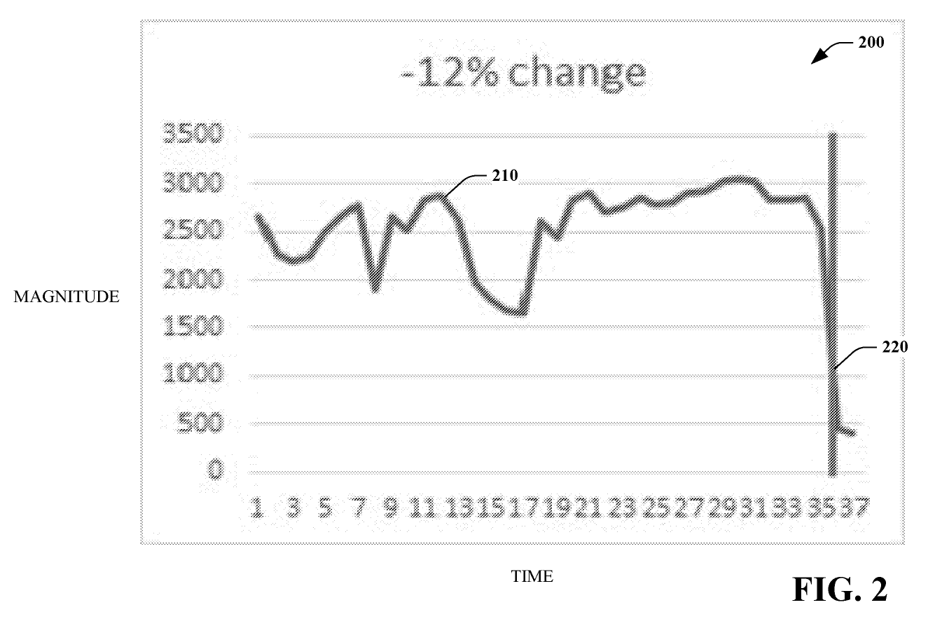

FIGS. 2-11 are graphs that illustrate example data for each of these scenarios.

Case 0

Referring to FIG. 2, a graph 200 an anomaly distribution 210 and an anomaly data point 220 for the following attributes:

TABLE 2

| | | Percent change | | |
|---|---|---|---|---|
| | Direction | (%) | Rank | Result |
| | −ve | −12 | 0 | Anomaly is shown to |
| Label | 0 | 0 | 0 | user. Impact is |
| | | | | reported as a percent |
| | | | | change value |

Using the rules set forth under “classification” in Table 1 above, the classifier component 130 provides the anomaly to the user with the corresponding determined result that the impact is reported as a percent change value.

Case 1

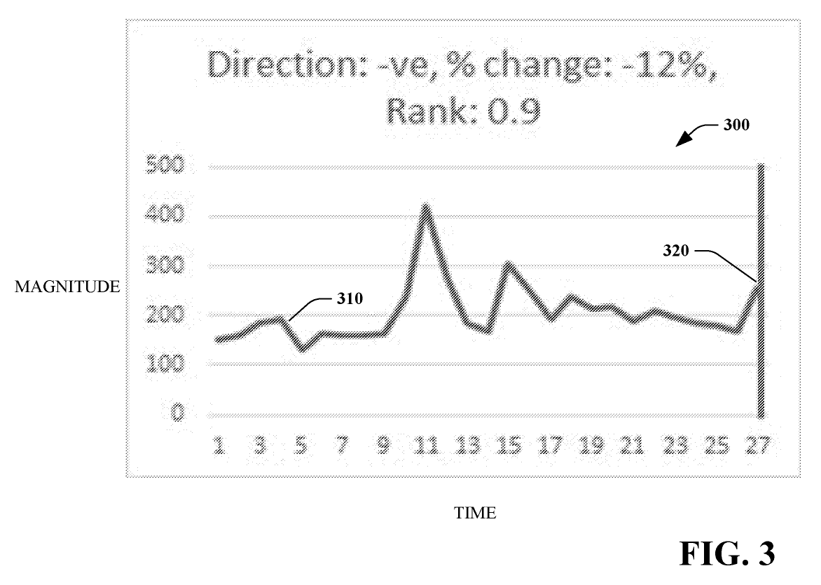

Referring to FIG. 3, a graph 300 an anomaly distribution 310 and an anomaly data point 320 for the following attributes:

TABLE 3

| | | Percent change | | |
|---|---|---|---|---|
| | Direction | (%) | Rank | Result |
| | −ve | −12 | 0.9 | Anomaly is not |
| Label | 0 | 0 | 1 | shown to user. |

Using the rules set forth under “classification” in Table 1 above, the classifier component 130 blocks the anomaly from the user.

Case 2a

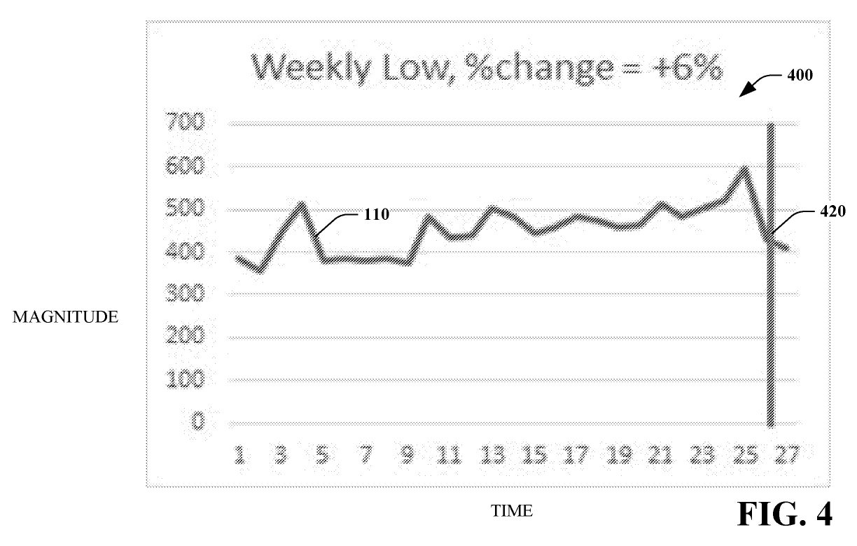

Referring to FIG. 4, a graph 400 an anomaly distribution 410 and an anomaly data point 420 for the following attributes:

TABLE 4

| | | Percent change | | |
|---|---|---|---|---|
| | Direction | (%) | Rank | Result |
| | −ve | 6 | 0 | Anomaly is shown to |
| Label | 0 | 1 | 0 | user. Impact is |
| | | | | reported as weekly |
| | | | | low |

Using the rules set forth under “classification” in Table 1 above, the classifier component 130 provides the anomaly to the user with the corresponding determined result that the impact is reported as a low for a predetermined period of time (e.g., weekly low).

Case 2b

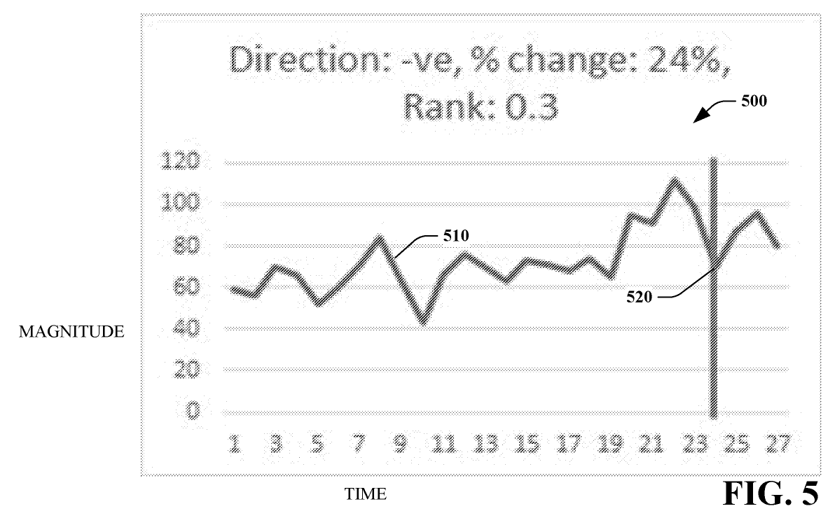

Referring to FIG. 5, a graph 500 an anomaly distribution 510 and an anomaly data point 520 for the following attributes:

TABLE 5

| | | Percent change | | |
|---|---|---|---|---|
| | Direction | (%) | Rank | Result |
| | −ve | 24 | 0.3 | Anomaly is not |
| Label | 0 | 1 | 0 | shown to user. |

Using the rules set forth under “classification” in Table 1 above, the classifier component 130 blocks the anomaly from the user.

Case 3

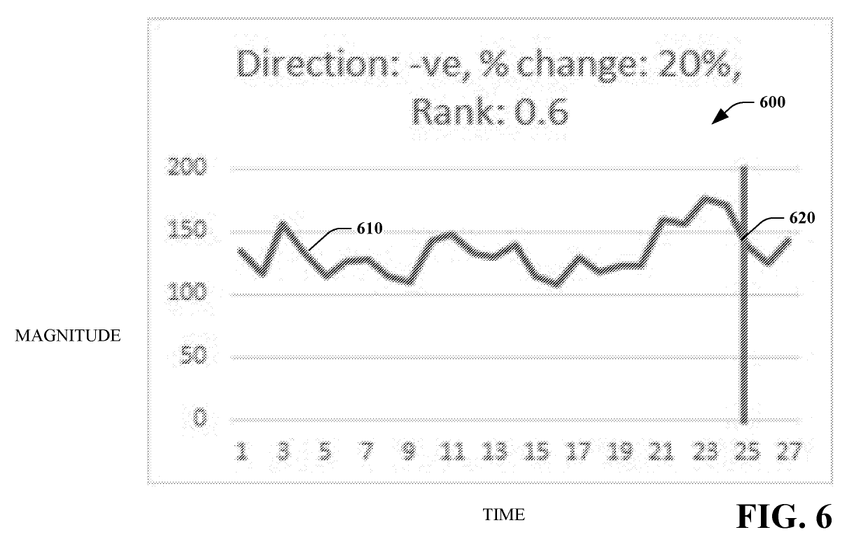

Referring to FIG. 6, a graph 600 an anomaly distribution 610 and an anomaly data point 620 for the following attributes:

TABLE 6

| | | Percent change | | |
|---|---|---|---|---|
| | Direction | (%) | Rank | Result |
| | −ve | 20 | 0.6 | Anomaly is not |
| Label | 0 | 1 | 1 | shown to user. |

Using the rules set forth under “classification” in Table 1 above, the classifier component 130 blocks the anomaly from the user.

Case 4

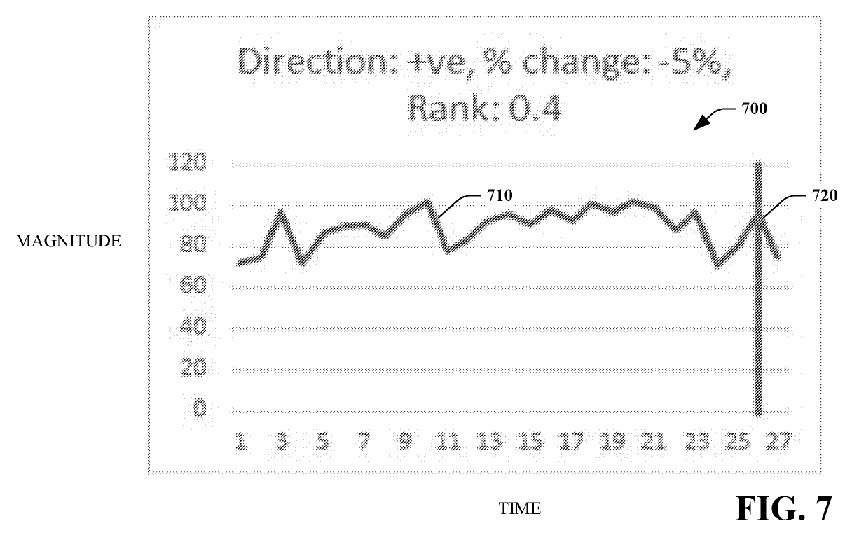

Referring to FIG. 7, a graph 700 an anomaly distribution 710 and an anomaly data point 720 for the following attributes:

TABLE 7

| | | Percent change | | |
|---|---|---|---|---|
| | Direction | (%) | Rank | Result |
| | +ve | −5 | 0.4 | Anomaly is not |
| Label | 1 | 0 | 0 | shown to user. |

Using the rules set forth under “classification” in Table 1 above, the classifier component 130 blocks the anomaly from the user.

Case 5a

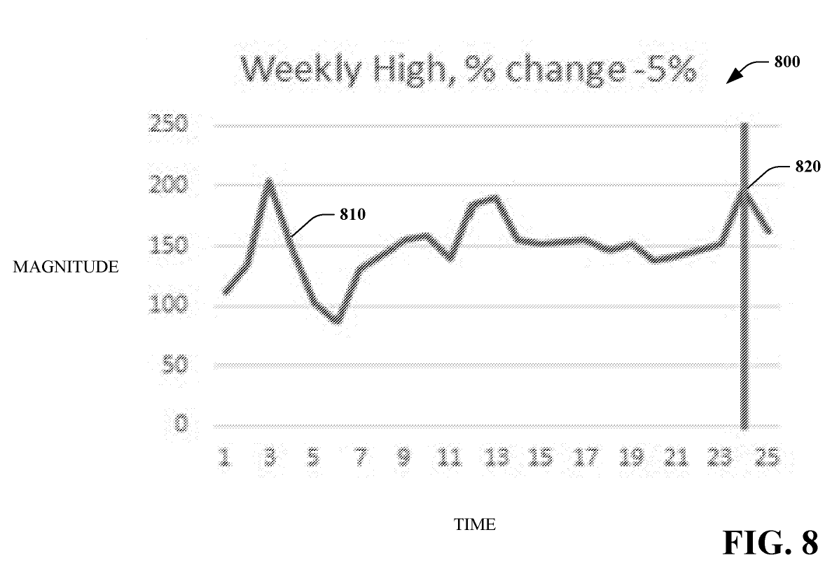

Referring to FIG. 8, a graph 800 an anomaly distribution 810 and an anomaly data point 820 for the following attributes:

TABLE 8

| | | Percent change | | |
|---|---|---|---|---|
| | Direction | (%) | Rank | Result |
| | +ve | −5 | 1 | Anomaly is shown to |
| Label | 1 | 0 | 1 | user. Impact is |
| | | | | reported as weekly |
| | | | | high |

Using the rules set forth under “classification” in Table 1 above, the classifier component 130 provides the anomaly to the user with the corresponding determined result that the impact is reported as a high for a predetermined period of time (e.g., weekly high).

Case 5b

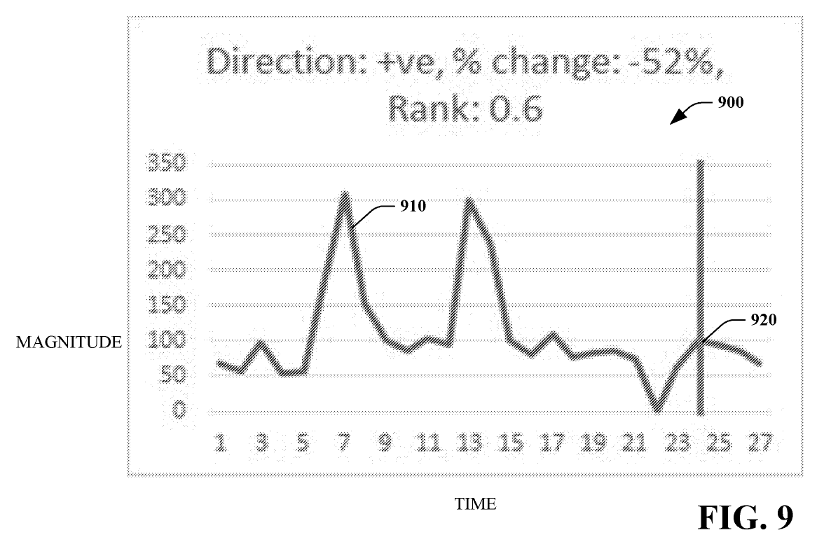

Referring to FIG. 9, a graph 900 an anomaly distribution 910 and an anomaly data point 920 for the following attributes:

TABLE 9

| | | Percent change | | |
|---|---|---|---|---|
| | Direction | (%) | Rank | Result |
| | +ve | −52 | 0.6 | Anomaly is not |
| Label | 1 | 0 | 1 | shown to user. |

Using the rules set forth under “classification” in Table 1 above, the classifier component 130 blocks the anomaly from the user.

Case 6

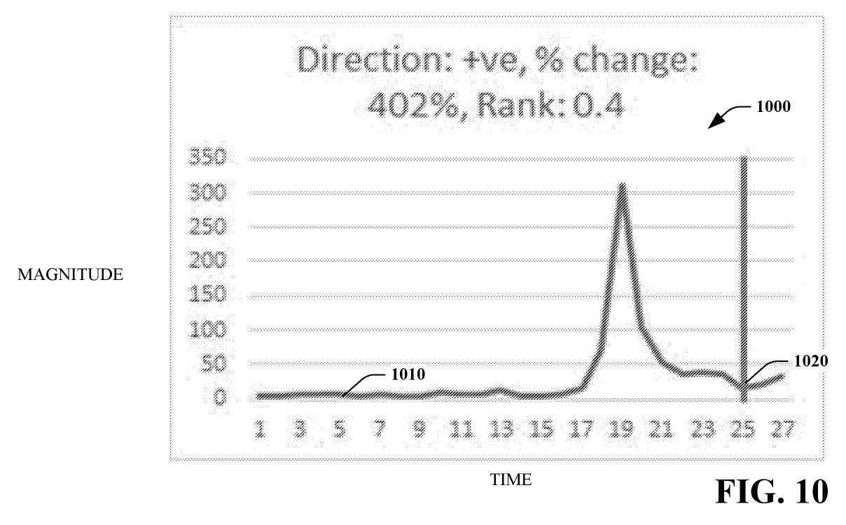

Referring to FIG. 10, a graph 1000 an anomaly distribution 1010 and an anomaly data point 1020 for the following attributes:

TABLE 10

| | | Percent change | | |
|---|---|---|---|---|
| | Direction | (%) | Rank | Result |
| | +ve | 402 | 0.4 | Anomaly is not |
| Label | 1 | 1 | 0 | shown to user. |

Using the rules set forth under “classification” in Table 1 above, the classifier component 130 blocks the anomaly from the user.

Case 7

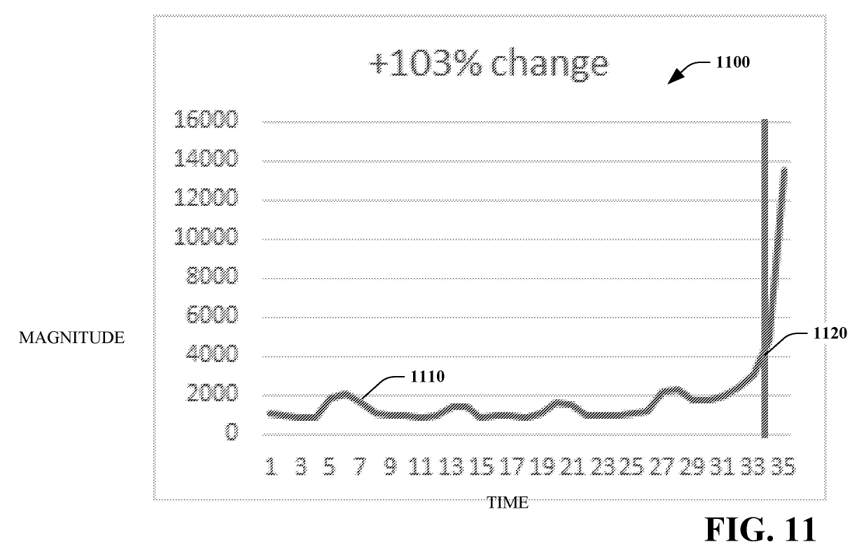

Referring to FIG. 11, a graph 1100 an anomaly distribution 1110 and an anomaly data point 1120 for the following attributes

TABLE 11

| | | Percent change | | |
|---|---|---|---|---|
| | Direction | (%) | Rank | Result |
| | +ve | 103 | 1 | Anomaly is shown to |
| Label | 1 | 1 | 1 | user. Impact is |
| | | | | reported as a percent |
| | | | | change value. |

Using the rules set forth under “classification” in Table 1 above, the classifier component 130 provides the anomaly to the user with the corresponding determined result that the impact is reported as the percent change value.

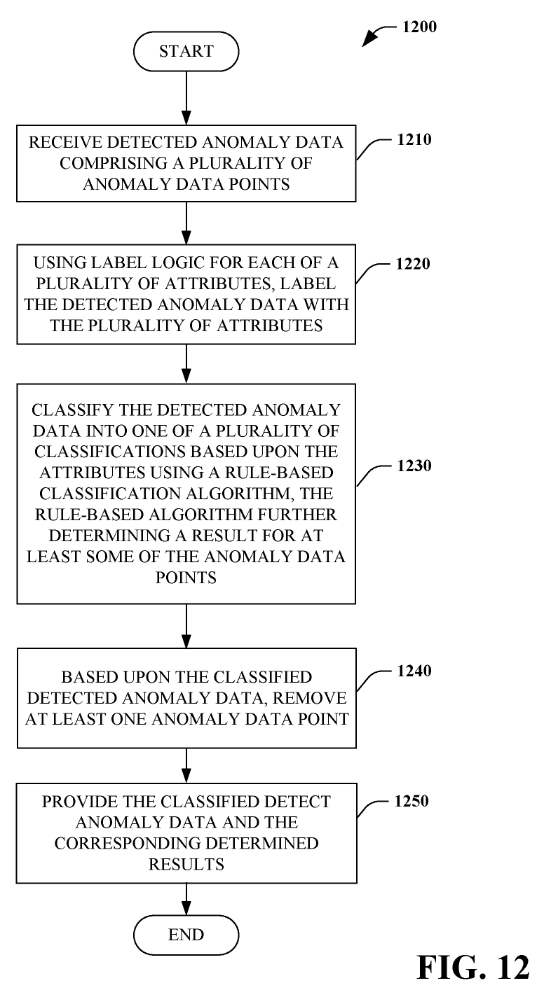

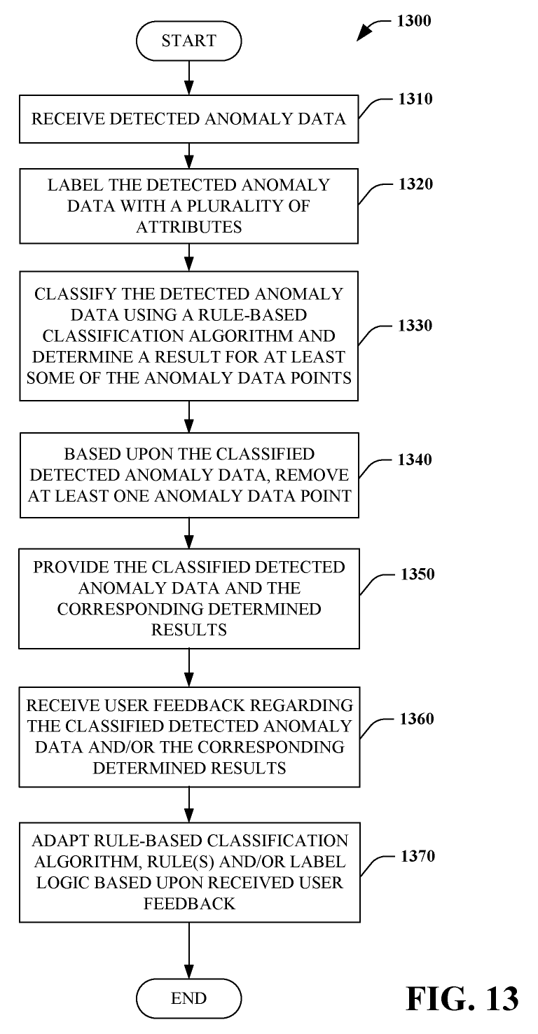

FIGS. 12 and 13 illustrate exemplary methodologies relating to rule-based classification for detected anomalies. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 12, a method of classifying detected anomalies 1200 is illustrated. In some embodiments, the method 1200 is performed by the system 100. At 1210, detected anomaly data comprising a plurality of anomaly data points is received. At 1220, using label logic for each of a plurality of attributes, the detected anomaly data is labeled with the plurality of attributes.

At 1230, the detected anomaly data is classified into one of a plurality of classifications based upon the attributes using a rule based classification algorithm. The rule based algorithm further determines a result for at least some of the anomaly data points. At 1240, at least one anomaly data point is removed based upon the classified detected anomaly data. At 1250, the classified detected anomaly data and the corresponding determined results are provided (e.g., to a user).

Next, turning to FIG. 13, a method of classifying detected anomalies 1300 is illustrated. In some embodiments, the method 1300 is performed by the system 100. At 1310, detected anomaly data is received. The detected anomaly data includes a plurality of anomaly data points. At 1320, the detected anomaly data is labeled with a plurality of attributes. Label logic can be used to label the detected anomaly data for each of the plurality of attributes,

At 1330, the detected anomaly data is classified using a rule based classification algorithm and a result is determined for at least some of the anomaly data points. The detected anomaly data can be classified into one of a plurality of classifications based upon the attributes.

At 1340, at least one anomaly data point is removed based upon the classified detected anomaly data. At 1350, the classified detected anomaly data and the corresponding determined results are provided (e.g., to a user).

At 1360, user feedback regarding the classified detected anomaly data and/or the corresponding determined results is received. At 1370, the rule-based classification algorithm, rule(s) and/or label logic is adapted based upon the received user feedback.

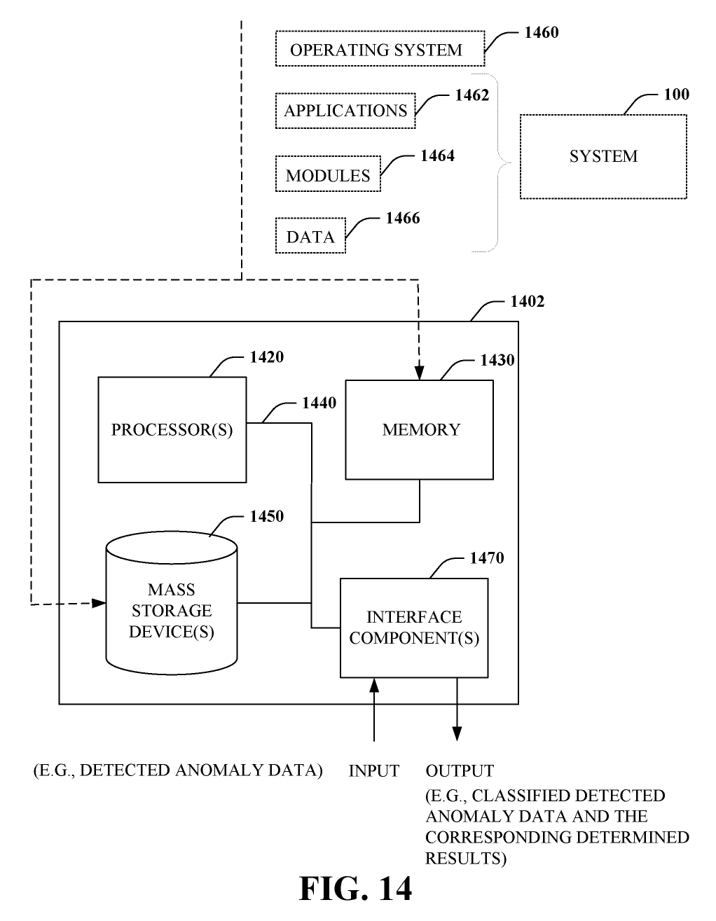

With reference to FIG. 14, illustrated is an example general-purpose computer or computing device 1402 (e.g., mobile phone, desktop, laptop, tablet, watch, server, hand-held, programmable consumer or industrial electronics, set-top box, game system, compute node, etc.). For instance, the computing device 1402 may be used in a system for classifying detected anomalies 100.

The computer 1402 includes one or more processor(s) 1420, memory 1430, system bus 1440, mass storage device(s) 1450, and one or more interface components 1470. The system bus 1440 communicatively couples at least the above system constituents. However, it is to be appreciated that in its simplest form the computer 1402 can include one or more processors 1420 coupled to memory 1430 that execute various computer executable actions, instructions, and or components stored in memory 1430. The instructions may be, for instance, instructions for implementing functionality described as being carried out by one or more components discussed above or instructions for implementing one or more of the methods described above.

The processor(s) 1420 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1420 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 1420 can be a graphics processor.

The computer 1402 can include or otherwise interact with a variety of computer-readable media to facilitate control of the computer 1402 to implement one or more aspects of the claimed subject matter. The computer-readable media can be any available media that can be accessed by the computer 1402 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 1402. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 1430 and mass storage device(s) 1450 are examples of computer-readable storage media. Depending on the exact configuration and type of computing device, memory 1430 may be volatile (e.g., RAM), non-volatile (e.g., ROM, flash memory, etc.) or some combination of the two. By way of example, the basic input/output system (BIOS), including basic routines to transfer information between elements within the computer 1402, such as during start-up, can be stored in nonvolatile memory, while volatile memory can act as external cache memory to facilitate processing by the processor(s) 1420, among other things.

Mass storage device(s) 1450 includes removable/non-removable, volatile/non-volatile computer storage media for storage of large amounts of data relative to the memory 1430. For example, mass storage device(s) 1450 includes, but is not limited to, one or more devices such as a magnetic or optical disk drive, floppy disk drive, flash memory, solid-state drive, or memory stick.

Memory 1430 and mass storage device(s) 1450 can include, or have stored therein, operating system 1460, one or more applications 1462, one or more program modules 1464, and data 1466. The operating system 1460 acts to control and allocate resources of the computer 1402. Applications 1462 include one or both of system and application software and can exploit management of resources by the operating system 1460 through program modules 1464 and data 1466 stored in memory 1430 and/or mass storage device (s) 1450 to perform one or more actions. Accordingly, applications 1462 can turn a general-purpose computer 1402 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 1462, and include one or more modules 1464 and data 1466 stored in memory and/or mass storage device(s) 1450 whose functionality can be realized when executed by one or more processor(s) 1420.

In accordance with one particular embodiment, the processor(s) 1420 can correspond to a system on a chip (SOC) or like architecture including, or in other words integrating, both hardware and software on a single integrated circuit substrate. Here, the processor(s) 1420 can include one or more processors as well as memory at least similar to processor(s) 1420 and memory 1430, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 1402 also includes one or more interface components 1470 that are communicatively coupled to the system bus 1440 and facilitate interaction with the computer 1402. By way of example, the interface component 1470 can be a port (e.g., serial, parallel, PCMCIA, USB, FireWire, etc.) or an interface card (e.g., sound, video, etc.) or the like. In one example implementation, the interface component 1470 can be embodied as a user input/output interface to enable a user to enter commands and information into the computer 1402, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 1470 can be embodied as an output peripheral interface to supply output to displays (e.g., LCD, LED, plasma, etc.), speakers, printers, and/or other computers, among other things. Still further yet, the interface component 1470 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for classifying detected anomalies, comprising:
a computer comprising a processor and a memory having computer-executable instructions stored thereupon which, when executed by the processor, cause the computer to:
receive detected anomaly data comprising a plurality of anomaly data points;
using label logic for each of a plurality of attributes, label the detected anomaly data with the plurality of attributes;
classify the detected anomaly data into one of a plurality of classifications based upon the attributes using a rule-based classification algorithm, the rule-based algorithm further determines a result for at least some of the anomaly data points; and
provide the classified detected anomaly data and the corresponding determined results.

2. The system of claim 1, the memory having further computer-executable instructions stored thereupon which, when executed by the processor, cause the computing device to:
remove at least one data anomaly point based upon the classified detected anomaly data.

3. The system of claim 1, the memory having further computer-executable instructions stored thereupon which, when executed by the processor, cause the computing device to:
receive user feedback regarding at least one of the classified detected anomaly data and the corresponding determined results; and
adapt the rule-based classification algorithm based upon the received user feedback.

4. The system of claim 1, the memory having further computer-executable instructions stored thereupon which, when executed by the processor, cause the computing device to:
receive user feedback regarding at least one of the classified detected anomaly data and the corresponding determined results; and
adapt a rule used by the rule-based classification algorithm based upon the received user feedback.

5. The system of claim 1, the memory having further computer-executable instructions stored thereupon which, when executed by the processor, cause the computing device to:
receive user feedback regarding at least one of the classified detected anomaly data and the corresponding determined results; and
adapt label logic for a particular attribute based upon the received user feedback.

6. The system of claim 5, wherein the label logic for the particular attribute is adapted using one or more machine learning algorithms including linear regression algorithms, logistic regression algorithms, decision tree algorithms, support vector machine (SVM) algorithms, Naive Bayes algorithms, a K-nearest neighbors (KNN) algorithm, a K-means algorithm, a random forest algorithm, dimensionality reduction algorithms, and/or a Gradient Boost & Adaboost algorithm.

7. The system of claim 1, wherein label logic for a particular attribute quantifies change and specifies criteria for labeling the particular attribute associated with a particular anomaly data point.

8. The system of claim 7, wherein the label logic for the particular attribute provides a Boolean value for the particular attribute.

9. The system of claim 1, wherein the plurality of attributes comprise at least one of direction, percent change, or rank.

10. A method of classifying detected anomalies, comprising:
receiving detected anomaly data comprising a plurality of anomaly data points;
using label logic for each of a plurality of attributes, labeling the detected anomaly data with the plurality of attributes;
classifying the detected anomaly data into one of a plurality of classifications based upon the attributes using a rule-based classification algorithm, the rule-based algorithm further determines a result for at least some of the anomaly data points; and
providing the classified detected anomaly data and the corresponding determined results.

11. The method of claim 10, further comprising:
removing at least one data anomaly point based upon the classified detected anomaly data.

12. The method of claim 10, further comprising:
receiving user feedback regarding at least one of the classified detected anomaly data and the corresponding determined results; and
adapting at least one of the rule-based classification algorithm, a rule used by the rule-based classification algorithm, or label logic for a particular attribute based upon the received user feedback.

13. The method of claim 10, wherein label logic for a particular attribute is adapted using one or more machine learning algorithms including linear regression algorithms, logistic regression algorithms, decision tree algorithms, support vector machine (SVM) algorithms, Naive Bayes algorithms, a K-nearest neighbors (KNN) algorithm, a K-means algorithm, a random forest algorithm, dimensionality reduction algorithms, and/or a Gradient Boost & Adaboost algorithm.

14. The method of claim 10, wherein label logic for a particular attribute quantifies change and specifies criteria for labeling the particular attribute associated with a particular anomaly data point.

15. The method of claim 14, wherein the label logic for the particular attribute provides a Boolean value for the particular attribute.

16. A computer storage media storing computer-readable instructions that when executed cause a computing device to:
receive detected anomaly data;
label the detected anomaly data with a plurality of attributes;
classify the detected anomaly data using a rule-based classification algorithm, the rule-based algorithm further determines a result for at least some of the anomaly data points; and
providing the classified detected anomaly data and the corresponding determined results.

17. The computer storage media of claim 16, storing further computer-readable instructions that when executed cause the computing device to:
remove at least one anomaly data point based upon the classified detected anomaly data.

18. The computer storage media of claim 16, storing further computer-readable instructions that when executed cause the computing device to:
receive user feedback regarding at least one of the classified detected anomaly data and the corresponding determined results; and
adapt at least one of the rule-based classification algorithm, a rule used by the rule-based classification algorithm, or label logic for a particular attribute based upon the received user feedback.

19. The computer storage media of claim 16, wherein label logic for a particular attribute is adapted using one or more machine learning algorithms including linear regression algorithms, logistic regression algorithms, decision tree algorithms, support vector machine (SVM) algorithms, Naive Bayes algorithms, a K-nearest neighbors (KNN) algorithm, a K-means algorithm, a random forest algorithm, dimensionality reduction algorithms, and/or a Gradient Boost & Adaboost algorithm.

20. The computer storage media of claim 16, wherein label logic for a particular attribute quantifies change and specifies criteria for labeling the particular attribute associated with a particular anomaly data point.
